(19) United States
(12) Patent Application Publication
(10) Pub. No.: US 2012/0176490 A1
(43) Pub. Date: Jul. 12, 2012

(54) System And Method For Analyzing Sheet Interleaving Material

(75) Inventors: Roger F. Bonham, JR., Portage, WI (US); Mark Purcell, De Forest, WI (US); Mark Robinson, Glossop (GB)

(73) Assignee: CARDINAL FG COMPANY, Eden Prairie, MN (US)

(21) Appl. No.: 12/986,597

(22) Filed: Jan. 7, 2011

(51) Int. Cl. H04N 7/18

(52) U.S. Cl. 348/86; 348/E07.085

(57) ABSTRACT

Embodiments provide for analyzing interleaving material applied to sheets of material traveling along a conveyor. A system is provided that includes a cross-conveyor support frame and a camera system to capture images of the interleaving material upon the sheets. The camera system may optionally include a movable camera head that travels along the support frame to capture images at multiple positions along substantially the entire width of the conveyor. A control module is provided that includes a processor programmed with instructions for analyzing the interleaving material based on the images. In some cases the analyzing includes receiving the images of the interleaving material from the camera system, assessing coverage of the interleaving material upon the sheets of material from the images, determining adjustments for application of the interleaving material based on the assessed coverage, and/or communicating the adjustments to an interleaving material applicator.

### FIELD

This disclosure generally relates to the use of interleaving materials upon stacked sheets, and more particularly relates to the application and/or analysis of interleaving materials upon glass sheets prior to stacking for transportation and/or storage.

### BACKGROUND

Glass sheets or panels (sometimes referred to as lites in the industry) are commonly stacked together for transportation and/or storage following production. For example, lites may be stacked in a variety of pack, box, pallet or rack configurations. While stacking multiple lites provides a convenient packaging configuration for transportation and/or storage, the close proximity and fragile nature of the lites can lead to scratching, marring, cracking, and/or breaking of the lites due to relative movement and/or collisions between adjacent lites. In addition, it is well known that water can slowly react with glass over time, leading to staining and corrosion of the glass when subject to prolonged exposure to even small amounts of water. For example, over time water reacts with soda-lime-silica glass and becomes highly alkaline and corrosive. Thus staining is a concern after lites are packaged and shipped because transportation and storage conditions cannot always be controlled.

To address these concerns, glass manufacturers commonly use a variety of interleaving materials between the surfaces of stacked glass sheets. The interleaving materials often include acid compounds to neutralize highly alkaline water and reduce stain damage to the sheets. The interleaving materials also provide physical separation of the glass sheet surfaces to minimize physical damage. A common interleaving material comprises polymethylmethacrylate (PMMA) beads for physical separation and adipic acid for neutralizing alkaline water.

Lite production facilities can use a variety of types of applicators to apply the interleaving materials to the surfaces of the glass sheets as the sheets advance along a conveyor. For example, interleaving materials may be mechanically dispersed in particulate form using a hopper. In another application, a powdered interleaving material is dispersed in an aqueous composition, such as in atomized water or in a conventional liquid application technique. In some cases the interleaving material may inherently provide a stain-inhibiting acid, while in some cases the interleaving material may also include individual stain-inhibiting acid materials and physical separation beads, which may be applied separately or as a heterogeneous mixture.

In addition to regularly inspecting lites for chips, scratches, and other deformities before stacking and packing, glass manufacturers may also from time to time inspect the interleaving material upon the glass sheets to determine whether the material has been adequately applied according to a desired standard. One common method of inspecting the interleaving material involves a worker removing a lite sample from the production line and inspecting the layer of interleaving material with a microscope.

### SUMMARY

Embodiments of the invention generally relate to the use of interleaving materials upon stacked sheets, and more particularly provide systems and methods for analyzing the interleaving material after it is applied to the sheets. In some embodiments, feedback is provided for adjusting subsequent application of the interleaving material based on the analysis.

According to a first aspect of the invention, a system for analyzing interleaving material on sheets of material to be stacked is provided. The system includes a cross-conveyor support frame, a camera system coupled to the support frame, and a control module coupled to the camera system. The cross-conveyor support frame is adapted to span across a conveyor that advances sheets of material to be stacked. The sheets of material have an interleaving material applied to at least one surface. The camera system is adapted to capture images of the interleaving material at multiple positions along a width of the conveyor. The control module includes a processor programmed with instructions for analyzing the interleaving material. In some cases the analyzing includes receiving the images of the interleaving material from the camera system and assessing coverage of the interleaving material upon the sheets of material from the images. The analyzing optionally includes one or more of determining adjustments for application of the interleaving material based on the assessed coverage and communicating the adjustments to an interleaving material applicator.

According to another aspect of the invention, a system is provided for applying an interleaving material to sheets of material that are to be stacked. The system includes a conveyor that advances sheets of material, e.g., through a portion of a production line. The system also includes an interleaving material applicator positioned proximate to the conveyor. The interleaving material applicator applies an interleaving material to the sheets of material as they advance along the conveyor. A cross-conveyor support frame is provided spanning across the conveyor, and a camera system is coupled to the support frame. The camera system is adapted to capture images of the interleaving material at multiple positions along a width of the conveyor as the sheets of material advance along the conveyor. The system also includes a control module coupled to the camera system and the interleaving material applicator. The control module includes a processor programmed with instructions for analyzing the interleaving material. In some cases the analyzing includes receiving the images of the interleaving material from the camera system and assessing coverage of the interleaving material upon the sheets of material from the images. The analyzing optionally includes one or more of determining adjustments for application of the interleaving material based on the assessed coverage and communicating the adjustments to an interleaving material applicator.

According to another aspect of the invention, a system is provided for analyzing interleaving material on sheets of material to be stacked. The system includes a cross-conveyor support frame adapted to span across a conveyor advancing sheets of material to be stacked. The sheets of material typically have an interleaving material applied to at least one surface of the sheets of material. The system also includes a camera system coupled to the support frame and a control module coupled to the camera system. The camera system includes a moving camera head that moves along the support frame to multiple positions along a width of the conveyor in order to capture images of the interleaving material at the multiple positions. The camera system also includes at least one light for illuminating the sheets of material and the interleaving material during image capture. The control module coupled to the camera system includes a processor programmed with instructions for analyzing the interleaving material from the images captured by the camera. The analysis includes flashing the at least one light, actuating the camera system to capture illuminated images of the interleaving material during the flashing, receiving the illuminated images of the interleaving material from the camera system, and assessing from the illuminated images coverage of each of at least two types of particles in the interleaving material upon the sheets of material.

According to another aspect of the invention, a method is provided for analyzing interleaving material on sheets of material to be stacked. The method includes moving a camera head along a support frame across a conveyor advancing sheets of material to be stacked. The sheets of material have an interleaving material applied to at least one surface of the sheets of material. The method also includes capturing with the camera head images of the interleaving material at multiple positions along a width of the conveyor and assessing coverage of the interleaving material upon the sheets of material from the images. Adjustments for application of the interleaving material are optionally determined based on the assessed coverage and communicated to an interleaving material applicator.

Some embodiments of the invention can provide one or more of the following features and/or advantages. In some cases, systems and/or methods provide real-time analysis of interleaving material on sheets advancing along a conveyor within a production line without the need to remove a sheet sample for manual inspection. The analysis can occur during a temporary stop of the production line, although in some cases the analysis can be performed in an on-line configuration without the need to stop production.

Among other features, the analysis can provide measurements of one or more of the number of particles, area coverage, total mass, and/or density of the interleaving material. In some cases the analysis can distinguish between different types of particles within the interleaving material and provide measurements corresponding to each different type of particle. This breakdown can be helpful for troubleshooting problems in the application of interleaving materials containing, for example, both separation beads and acid particles.

In some cases, analysis and/or measurements are displayed or made otherwise available to manufacturing personnel. Actions for addressing any perceived application problems can then be determined and applied. In some embodiments the control module of the system determines adjustments for applying the interleaving material based on the analysis. Optionally, the analysis system is communicatively coupled with one or more parts of a production line, such as an interleaving material applicator. The system provides a feedback control or communication to the plant, thus providing a closed loop control of interleaving material application.

Some embodiments provide one or more analyses of the application of interleaving material. For example, an analysis may provide the average density of the interleaving material across an entire sheet of material, thus providing feedback on the overall level of interleaving material being applied to the sheet. In another example, an analysis determines a profile of the density of interleaving material across the width of a sheet of material, thus enabling specific problem areas to be targeted quickly and efficiently.

Thus, some embodiments can monitor, report, and/or correct for too little or too much interleaving material on the entire sheet as a whole, or at specific points along the width of a sheet of material. Monitoring and correcting for too little interleaving material being applied can help ensure that a sufficient level of interleaving material is applied to the sheets, thus leading to a reduction of glass quality rejections based on stained glass. In addition, ensuring adequate material coverage can reduce motion scratches during shipping and reduce the likelihood that adjacent sheets may adhere together. Monitoring and correcting for too much interleaving material is also helpful in some cases. For example, ensuring optimum coverage of the interleaving material may allow for a reduction in the amount of interleaving material being applied, thus generating a cost saving. In addition, excess interleaving material can make washing the glass more difficult for downstream processors who must wash the glass before performing value added work, such as coating applications. Inadequate washing may leave an interleaving residue that detrimentally affects the subsequent value added work. In addition, reducing the overall amount of interleaving material used can decrease the excess interleaving material that tends to accumulate in and around the area of application, e.g., the plant conveyor and/or other equipment, which may also decrease the need for equipment cleaning and/or the risk of slipping on the interleaving material.

These and various other features and advantages will be apparent from a reading of the following detailed description.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a top view of a conveyor assembly including a system for analyzing interleaving material on sheets of material according to some embodiments of the invention.

FIG. 2 is a schematic view of a system for analyzing interleaving material on sheets of material on a conveyor according to some embodiments of the invention.

FIG. 3 is a schematic view of a system for analyzing interleaving material on sheets of material on a conveyor according to some embodiments of the invention.

FIG. 4 is a view of a camera head according to some embodiments of the invention.

FIG. 5 is a depiction of a user interface displaying a camera image of interleaving material according to some embodiments of the invention.

FIG. 6 is a depiction of a user interface displaying results determined based on multiple camera images according to some embodiments of the invention.

FIG. 7 is a depiction of a user interface displaying trends in coverage of an interleaving material along an X axis according to some embodiments of the invention.

FIG. 8 is a depiction of a user interface displaying trends in coverage of an interleaving material along a Y axis according to some embodiments of the invention.

FIG. 9 is a depiction of a user interface displaying a graph of the density of an interleaving material across a portion of sheet of material according to some embodiments of the invention.

FIG. 10 is a depiction of a user interface displaying a graph of the density of an interleaving material across a portion of sheet of material according to some embodiments of the invention.

FIG. 11 is a flow chart illustrating a method for analyzing interleaving material on sheets of material to be stacked according to some embodiments of the invention.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Although embodiments of the invention are described herein as analyzing interleaving material upon glass sheets, it is contemplated that embodiments of the invention may be useful for analyzing and/or applying interleaving materials to other types of sheet material, and the invention is not limited in this regard.

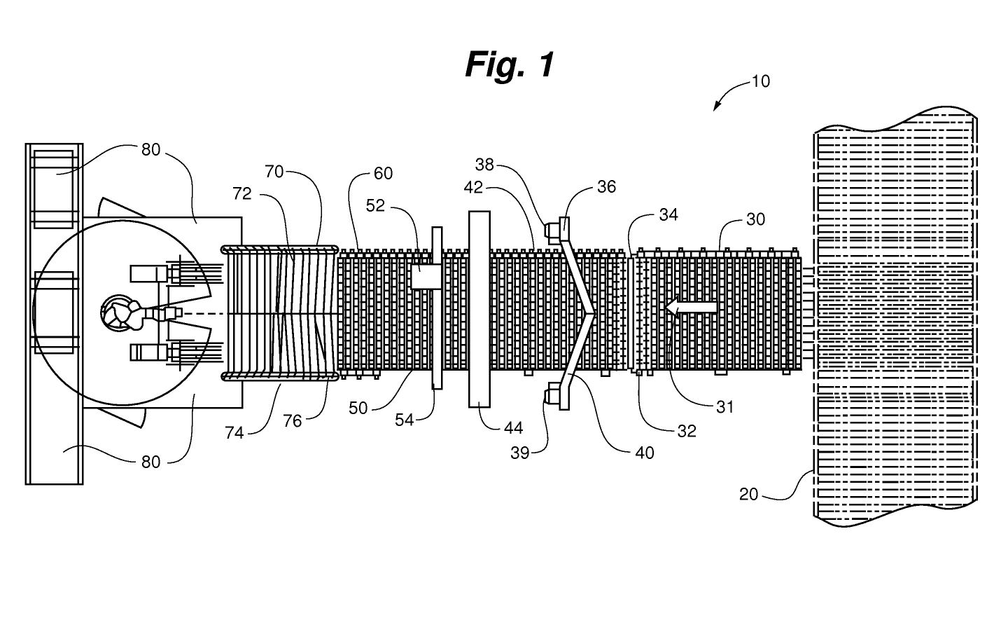

FIG. 1 is a top view of a conveyor assembly 10 including a system for analyzing interleaving material applied to glass sheets or lites according to some embodiments of the invention. According to some embodiments, a known float glass process generates an endless ribbon of glass (not shown) that is conveyed over a mainline conveyor 20 and scored for subsequent formation of caps and lites via conventional scoring processes known within the art. After being scored on the mainline conveyor 20, the glass ribbon is snapped via known glass-snapping mechanisms along the cross machine direction scores to produce caps. The produced caps are subsequently presented onto a roller conveyor 30 for introduction into snap roll assembly 32 for the formation of lites. As illustrated, the roller conveyor 30 is positioned perpendicular to the mainline conveyor 20; however, other suitable arrangements may be utilized as known within the art. The roller conveyor 30 may possess any suitable dimension and speed in accord with industry standards and desires. In some cases the roller conveyor 30 and the snap roll assembly 32 are rotatable via conventional drive shafts, timing belts and motors as known within the art.

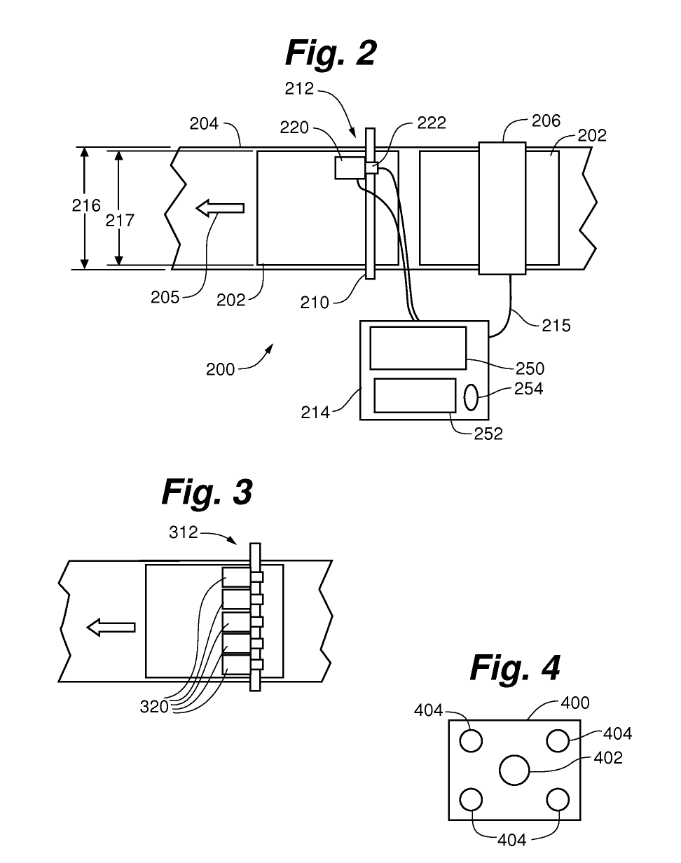

The roller conveyor 30 conveys the caps in a direction 31 toward the snap roll assembly 32, where the caps are received and subsequently snapped therein via known glass snapping mechanisms along the machine direction scores to produce lites (shown in FIG. 2). Lites may possess any suitable dimension in accord with industry standards and desires. A hold down assembly 34 preferably assists in preventing the scored caps from lifting up during the snapping process to produce lites.

Following the production, the lites are introduced into a chip blower assembly 36, which functions to clean/remove glass chips/fragments from the surface of the lites after the snapping process. The chip blower assembly 36 possesses two blowers 38 and 39 that are opposingly mounted on the sides of a V-shaped tube 40. In some cases the V-shaped tube 40 is frontally formed as an air knife to channel air generated by blowers 38 and 39 onto the lites.

The chip blower assembly 36 is further positioned over an acceleration conveyor 42. Thus, while the lites are subjected to the chip blower assembly 36, they are also simultaneously conveyed over acceleration conveyor 42, which accelerates the lites and thus create gaps between each lite for facilitation of the stacking process of lites. The acceleration conveyor 42 may possess any suitable dimension and speed in accord with industry standards and desires. In some cases the acceleration conveyor 42 is rotatable via conventional drive shafts, timing belts and motors as known within the art.

Once past acceleration conveyor 42, the lites pass by an interleaving material applicator 44, which applies, disperses, and/or distributes an interleaving material upon the lites. The interleaving material applicator 44 can incorporate any known techniques for applying interleaving materials. In some cases the applicator 44 mechanically disperses a particulate form of interleaving material (e.g., synthetic polymeric beads or natural porous cellulose materials such as wood flour) using, for example, a hopper. In some cases, the applicator 44 disperses an aqueous solution of a powdered interleaving material, such as in atomized water or in a conventional liquid application technique such as drip, flow, roll coating, conventional spray, reciprocating spray, rotary spray, or curtain spray. In some cases the interleaving material includes a mixture of physical separation beads and stain-inhibiting acid particles containing, e.g., boric acid, citric acid or tartaric acid.

After application of the interleaving material, the lites are introduced onto an inspection conveyor 50. According to some embodiments of the invention, the inspection conveyor 50 provides inspection of one or more characteristics of the lites. For example, in some embodiments a camera system 52 is coupled to a support frame 54 spanning the conveyor 30. The camera system 52 allows for capturing multiple images of the lites, thus enabling ready inspection of the lites via the images. As will be further discussed herein, in some cases the camera system 52 is part of an analysis system which allows for the analysis of interleaving material on the lites. Of course the camera system 52 can allow for inspection of other aspects of the lites, and/or one or more additional camera systems may be provided for dedicated inspection of other aspects of the lites. For example, in some cases the lites are inspected with a camera system in order to remove damaged and/or defective lites from the conveyor 30 prior to packaging. The inspection conveyor 50 may possess any suitable dimension and speed in accord with industry standards and desires. The inspection conveyor 50 is rotatable via conventional drive shafts, timing belts and motors as known within the art.

Following application of the interleaving material and inspection on the inspection conveyor 50, the lites may be advanced to a stacker (e.g., a single or double tipple assembly) 60, which permits the rejection of damaged/defective lites. In some cases the rejected lites are then removed and crushed via an infeed conveyor as known in the art. The stacker 60 may possess any suitable dimension and speed in accord with industry standards and desires. In some embodiments, the stacker 60 is rotatable via conventional drive shafts, timing belts and motors as known within the art.

Upon leaving the stacker 60, the lites are introduced onto an alignment conveyor 70 that aligns the outer edge of each lite. In some cases the first half of the alignment conveyor 70 is designed as a chevron conveyor, thus allowing the lites to be pushed to outer tank tracks 72 and 74 in this double stream arrangement. A bar 76 assists in the separation of the lites into two streams of lites for eventual introduction into separate rotating elements of stacking apparatuses 80 for subsequent stacking of the lites, as is known in the art. The alignment conveyor 70 may possess any suitable dimension and speed in accord with industry standards and desires. The alignment conveyor 70 is preferably rotatable via conventional drive shafts, timing belts and motors as known within the art.

It should be appreciated that FIG. 1 illustrates just one example of a conveyor assembly as part of a glass sheet production line. Of course it is contemplated that the type, number, position, order, and/or arrangement of devices and mechanisms along the line, as well as aspects of the conveyors themselves, can be modified as known in the art depending upon a particularly desired configuration.

FIG. 2 is a schematic view, according to some embodiments of the invention, of a system 200 for analyzing an interleaving material on glass sheets or lites 202 and a portion of a conveyor 204 that advances the lites 202 in a first direction 205. The conveyor 204 can be a part of any production line configuration, such as the example shown in FIG. 1. The conveyor 204 can be provided with rollers, a belt, or any other suitable configuration, and may have any suitable dimensions, speed, etc. In some cases the conveyor may have a width extending up to about 5,400 mm. In some cases the conveyor speed may reach as high as 120 m/min.

The interleaving material is applied to the lites 202 by an interleaving material applicator 206. The interleaving material can be any suitable material known in the art. In some cases the applicator 206 may apply a mixture of synthetic polymeric beads (e.g., poly(methyl methacrylate) (PMMA)) or natural porous cellulose materials such as wood flour, along with particles of a stain-inhibiting acid such as boric acid, citric acid, tartaric acid, or adipic acid. For example, one mixture of interleaving material useful for separating sheets of material contains about 65% synthetic polymeric beads and about 35% acid particles by mass.

The applicator 206 may apply the interleaving material using any known technique, such as mechanical dispersion, atomization, and/or conventional liquid application techniques. In some cases the applicator 206 includes a metering device that distributes interleaving material using vibration metering. The metering device is fed by a hopper or reservoir of powdered interleaving material and in turn feeds one or more powder hoses and nozzles. The amount of interleaving material distributed by the metering device can be controlled by adjusting the device's “metering gap” and/or by changing the intensity of the device's vibrations. In some cases a metering device can distribute interleaving material to multiple nozzles through a common powder hose and a nozzle pipe or spray bar positioned over the conveyor. Examples of some possible metering devices are those available from GRAFIX USA LP, Bolingbrook, Ill.

According to some embodiments of the invention, the system 200 includes a cross-conveyor support frame 210, a camera system 212 coupled to the support frame 210, and a control module 214 coupled to the camera system 212. The system 200 also includes the interleaving material applicator 206, which is communicatively coupled with the control module 214, thus optionally allowing the control module 214 to adjust application of the interleaving material based on the analysis. However, in some embodiments the applicator 206 may not be considered a part of the analysis system 200. For example, in some cases the applicator 206 may not communicate with the control module 214 to adjust material dispersion and the control module may only provide functions such as analysis of the interleaving material and subsequent reporting.

The cross-conveyor support frame 210 can be provided in any suitable form capable of positioning the camera system 212 within the desired proximity to the lites 202 and the conveyor 204. For example, the support frame 210 may be provided as a gantry suspended above the conveyor 204 with vertical support members attaching the gantry to a support surface below, to the side, and/or above the conveyor 204. In the some embodiments the support frame 210 may alternatively extend below the conveyor 204, thus allowing the attached camera system 212 to image the lites 202 from below the conveyor 204. According to some embodiments, the support frame 210 at least spans the width 216 of the conveyor 204 and the width 217 of the lites 202.

The camera system 212 includes one or more cameras capable of capturing images of the lites 202 and the interleaving material applied to the lites 202. For example, the camera system may include one or more digital still cameras, although video cameras are also contemplated. In the embodiment shown in FIG. 2, the camera system 212 includes a single camera head 220 movably mounted to the support frame 210, allowing the camera head 220 to travel along the support frame across the width of the lites 202 and the width of the conveyor 204. The single camera head 220 (e.g., including a single camera) can thus be used to capture images of the interleaving material at multiple positions along the width of the conveyor 204. In some cases the analysis system thus has a virtual field of view across the entire width, or substantially the entire width, of the conveyor 204 and the lites 202. This allows for a more thorough or detailed inspection of the interleaving material application at multiple points along or across the width of the advancing stream of lites.

Any suitable movement mechanism 222 can be used to move the camera head 220 along the support frame 210. For example, the camera head 220 may roll or slide along the support frame 210 with the assistance of motor driven wheels, trolleys, sliders, etc. The linear speed of the head can vary, depending for example, on whether multiple images are to be captured across the width of a single lite. In one embodiment the camera head 220 has a cross-conveyor speed of about 200 mm/s. The movement mechanism 222 may move the camera head 220 through a continuous range of multiple positions or a series of multiple discrete positions along the support frame. In some cases control of the movement mechanism 222 is provided by the control module 214, which may be communicatively coupled to the movement mechanism 222 via a wired or wireless connection. Other known cables, mounts, adjusters, motors and/or drives may also be incorporated in the design of the movement mechanism as desired.

Turning to FIG. 3, in some embodiments of the invention, a camera system 312 including multiple cameras or camera heads 320 may be provided as an alternative or in addition to a moving camera head. For example, a number of camera heads 320 may be attached to a support frame 310 in a fixed or stationary manner at multiple positions across the width of the conveyor and the stream of lites. The individual fields of view of the multiple camera heads can thus provide an effectively larger virtual field of view, which can be used to inspect the interleaving material application along the entire width, or substantially the entire width, of the conveyor and lites.

FIG. 4 is a view showing the face of a camera head 400 according to some embodiments of the invention. The camera head 400 includes a single camera 402, which as mentioned before, may be a digital still camera, although other types of cameras are contemplated. According to some embodiments of the invention, a camera head includes at least one and sometimes more than one light for illuminating the lites and the interleaving material during image capture. As shown in FIG. 4, in some cases the camera head 400 include four lights 404 spaced about the camera 402 in the face of the camera head 400. Such an arrangement can provide high levels of illumination along each of the major axes of the camera. Of course other configurations of lights may be used, including a greater or fewer numbers of lights arranged in a similar or different fashion. Any suitable light can be used for illumination, including flash bulbs and tubes. For example, in some cases multiple xenon strobe lights are incorporated into the camera head 400.

The camera 402 may be chosen to meet desired performance characteristics based on factors such as the speed of the conveyor, the speed of cross-conveyor movement if any, the size of the particles within the interleaving material, the desired imaging resolution, the physical configuration of the camera system and support frame, and other such factors. In one embodiment a camera having a frame rate of about 12 frames per second is used in conjunction with a conveyor belt traveling about 120 meters per minute.

Two potential camera configurations useful for interleaving materials of different size are shown in Table 1 below:

TABLE 1

| | | |
|---|---|---|
| Minimum particle size: | <=70 microns | >70 microns |
| Field of View: | 15 × 12 mm | 25 × 21 mm |
| Number of Pixels: | 2448 × 2050 | 2448 × 2050 |
| Pixel Size: | about 6 microns | about 10 microns |

In some cases different fields of view (and thus different pixel sizes) can be obtained by changing the height of the camera with respect to the lites. In one embodiment the camera is mounted above the conveyor with one or more extension tubes of different lengths. In one example, a first extension tube provides the camera system with 33 millimeters of extension to provide a first field of view. A second extension tube provides the camera system with an additional 6 millimeters of extension to reduce the field of view for smaller powder particles. In addition, in some cases more or less resolution may be required, which may affect the choice of camera configuration. For example, in some cases it may not be necessary to distinguish between different types of interleaving particles, and thus a larger pixel size and larger field of view can be used.

Returning to FIG. 2, the control module 214 is coupled with the camera system 212 and the movement mechanism 222, thus allowing the control module 214 to operate the camera system 212 and the movement mechanism 222. According to some embodiments, the control module 214 may be implemented in hardware, software, or a combination of both hardware and software. The control module 214 illustrated in FIG. 2 includes a programmable processor (not shown), memory (not shown), and input/output devices such as a display 250, a keyboard 252, and a pointing device 254. The processor may be implemented in any suitable manner, such as a hardware circuit comprising custom VLSI circuits or gate arrays, off-the-shelf semiconductors such as logic chips, transistors, or other discrete components. The processor may also be implemented in programmable hardware devices such as field programmable gate arrays, programmable array logic, programmable logic controllers and the like. In some embodiments the processor is a microprocessor in a computer. In some embodiments the control module 214 may include any number of additional features and/or connections, including an interface and connection to a plant controller and other devices, and input/output ports such as Ethernet or serial ports, along with an opto-isolated 24V digital line in some cases. In some embodiments the control module 214 includes a control line 215 coupled with the interleaving material applicator 206 for communicating adjustments to the application of interleaving material. For example, in one case the control line 215 provides a 0-10 VDC output signal that provides analog control of the dispersal rate of the applicator 206.

According to some embodiments, the processor is programmed with instructions (e.g., coded in hardware, firmware, and/or software) for controlling the camera system 212 and the movement mechanism 222, as well as analyzing images received from the camera system 212 to assess the interleaving material upon the sheets 202. The processor may be further programmed to receive the images from the camera system 212 and analyze the images in order to characterize the interleaving material upon the lites 202.

For example, in some embodiments the processor is programmed to move the camera head 220 to multiple positions along the support frame 210 (and thus along the width of the conveyor) and actuate the camera to capture images of different portions of the lites 202 and interleaving material passing by the camera. The image capture rate is preferably determined based on the desired tracking plan (e.g., the number of images requested per sheet), the frame rate of the camera, and the speed of the conveyor. In the event that the tracking plan calls for more images per sheet than is possible given the frame rate and conveyor speed, the processor may actuate the camera to capture the desired number of images across multiple sheets. As an example, a tracking plan may call for an image every 4 inches along a sheet. If this rate is incompatible with the camera frame rate and conveyor speed, the processor may be programmed to break up the tracking plan to instead capture the desired images across two sheets. Thus, the camera system may capture an image every 8 inches on a first sheet (e.g., at 4 inches, 12 inches, 20 inches, etc.), and then capture an alternating image every 8 inches on the next sheet (e.g., at 8 inches, 16 inches, 24 inches, etc.).

Of course, a number of variations in the timing for image capture are possible. In some cases the processor is programmed to actuate the camera head 220 to capture multiple successive images at each position before moving the camera head to another position. This allows the system to capture a series of images at each of the positions, allowing for analysis of long term trends in the application of the interleaving material across the width of the conveyor 204. In some embodiments the processor is programmed to time the image capture with the speed of the conveyor 204 in order to capture a single image per lite 202 passing by the camera system. More than one image per lite may also be captured in some cases. For example, the camera system 212 may be timed with the conveyor 204 to capture two or more images of a lite for a single position along the width of the conveyor 204. Of course, the camera system may capture any other combination of images per lite depending upon the speed and timing of the camera system and conveyor.

As discussed with reference to FIG. 4, in some cases the camera system includes one or more lights 404 for illuminating the sheet during image capture. According to one embodiment of the invention, four strobe lamps are symmetrically positioned about the camera lens to provide a high level of illumination along multiple camera axes. The lights are preferably illuminated long enough for the camera to capture light reflected from the interleaving material upon the sheets. In one example, the camera system has a minimum integration time of 80 μs per frame and the lights are flashed for approximately 1 μs after the camera begins acquiring a frame. Of course other durations may be used and the scope of the invention is not limited in this regard.

In some cases the processor may employ image analysis and recognition routines to assess the coverage of the interleaving material upon the lites. For example, in some cases a blob analysis of a captured image can be used to identify and characterize particles of the interleaving material. A blob analysis and/or other image processing techniques can be used to determine (directly or by inference) the number of particles of the interleaving material (e.g., within varying unit areas), the area coverage, the total mass of the material, and/or the density of the material across a portion of a lite, among other characteristics.

The processor is optionally programmed to analyze the interleaving material while also distinguishing between different types of particles within the material (e.g., polymeric separation beads, acid particles, indeterminate particles, etc.). In one embodiment the processor employs an image processing routine that distinguishes particles based on how light from the camera system (e.g., lights 404 in FIG. 4) is reflected by the particles. One possible interleaving material that can be used includes polymeric separation beads and acid particles that reflect light differently. The separation beads are generally spherical in shape with a substantially constant diameter and smooth surface, and thus reflect light from the camera system in a structured way based on the generally symmetrical curvature of the beads. In contrast, the acid particles are irregularly shaped flakes with a textured surface, and therefore diffusely reflect the light from the camera system. Thus, by illuminating the interleaving material upon the lites, the separation beads are distinguishable from the acid particles in the captured image using a suitable image processing technique (e.g., template matching) and/or visually to the human eye.

According to some embodiments, the processor may be programmed to perform an imaging process that determines the size of interleaving material particles (e.g., including beads and/or acid particles) based on light reflected by the particles. Such an analysis can assist in determining the relative amount of each type of particle upon the lites. Referring to FIG. 4, in one embodiment four lights 404 are positioned about the camera 402 in the face of the camera head 400. When energized, the lights 404 are reflected in the separation beads as a mirror image showing the four lights slightly distorted by the curvature of the beads. Thus the beads reflect the light in a structured manner. Due to the curvature of the beads, the reflected lights will appear farther apart for larger beads than for those having a smaller width or diameter. Analyzing the distance between the four lights in the reflected image can thus give an indication of the size of the bead. The size of acid particles (which appear to diffusely reflect the light) may be indicated from a pixel count and average particle thickness factor derived from known properties of the interleaving powder. According to one embodiment, the system is adapted to detect individual interleaving material particles as small as about 20 microns and up to or exceeding about 650 microns. The analysis may include determining one or more of the number, area, mass, and/or density of the interleaving material broken down by different types of particles.

Fewer or greater than four lights may be used depending upon the accuracy and reliability of the particular imaging routine being used. For simpler processing routines it is generally helpful to include more lights rather than less because the distance between any two reflected lights is smaller. This decreases the likelihood that the imaging routine will interpret two farther apart light reflections as belonging to two different beads when in reality they belong to the same bead. Of course any combination is possible and the invention is not limited in this regard. In one case using four strobe lights, and a simple blob analysis, Applicants have discovered that the system is about 98.5% accurate in distinguishing PMMA beads from adipic or boric acid particles.

After capturing one or more images of the interleaving material and assessing/analyzing coverage of the material upon the lites 202, the control module 214 may further provide one or more reporting features to inform plant personnel of the current state of interleaving material application. For example, the control module processor may be programmed with instructions for displaying detailed visual data in real-time with corresponding measurement displays, as well as data and statistics across one or more time periods. Reporting features can range from simple measurement breakdowns to long-term trending and statistics. In some cases data is displayed in a format compatible with popular spreadsheet or other analysis packages, allowing comprehensive management reports to be produced easily and quickly. Summary reports may also be automatically printed to any printer on the network at user-configurable times such as at the end of a shift.

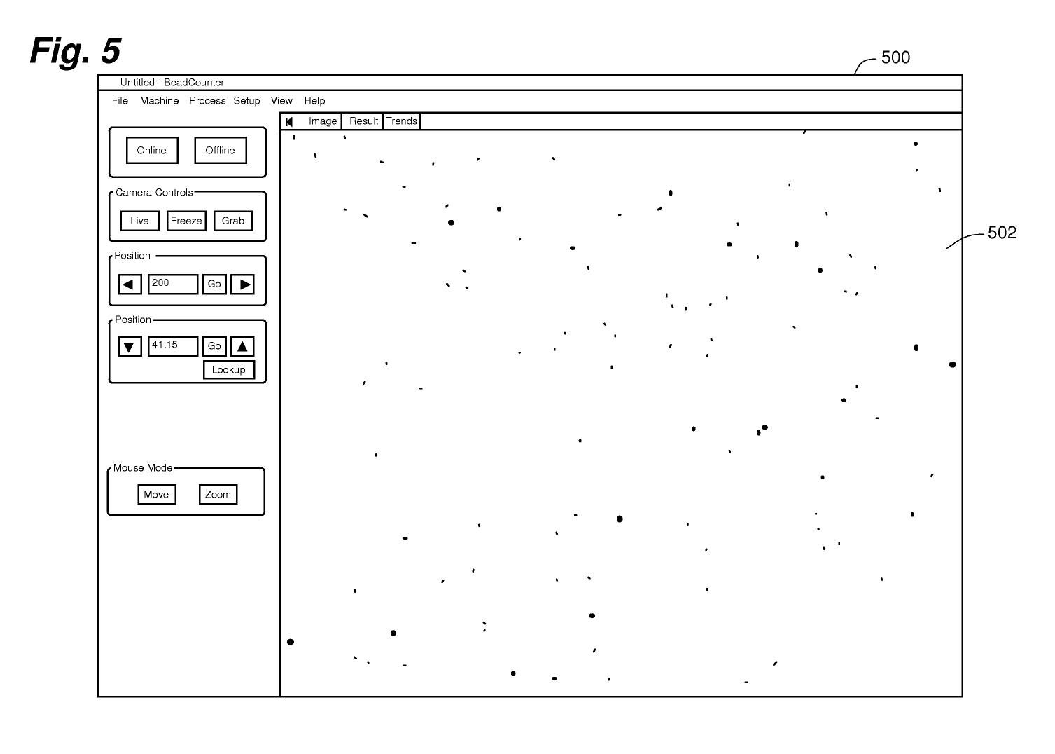

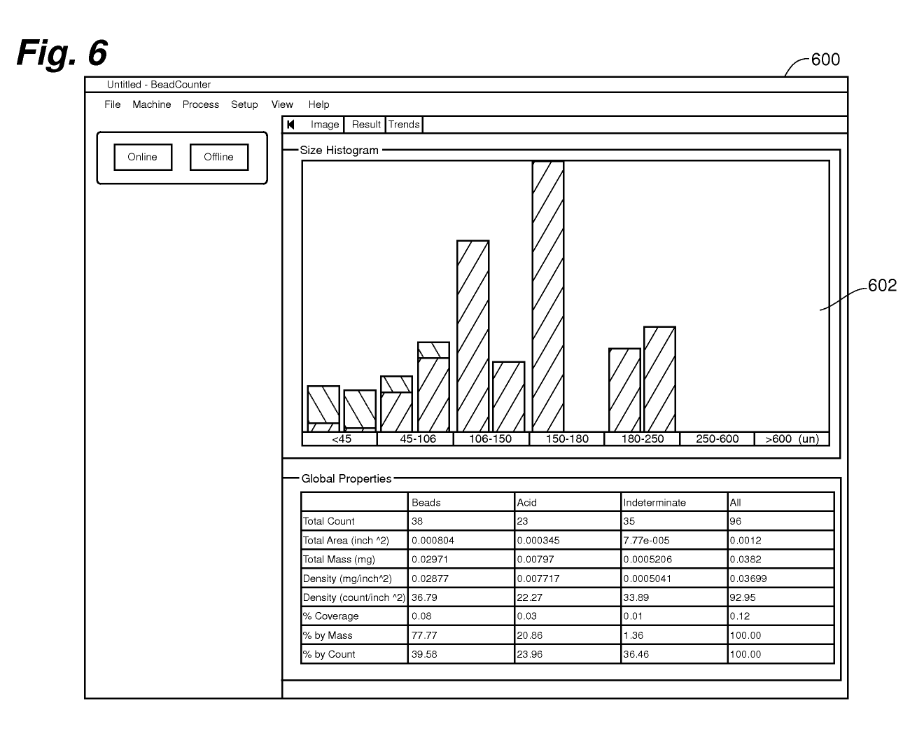

FIGS. 5-10 provide examples of various user interface displays that can be generated by the control module 214 according to different embodiments of the invention. For example, FIG. 5 is a depiction of a user interface 500 displaying a camera image 502 of interleaving material, showing the dispersion of interleaving particles and optionally distinguishing interleaving particle types by color, shading, or other marking. FIG. 6 is a depiction of a user interface 600 displaying a histogram 602 of interleaving particle characteristics determined based on multiple camera images.

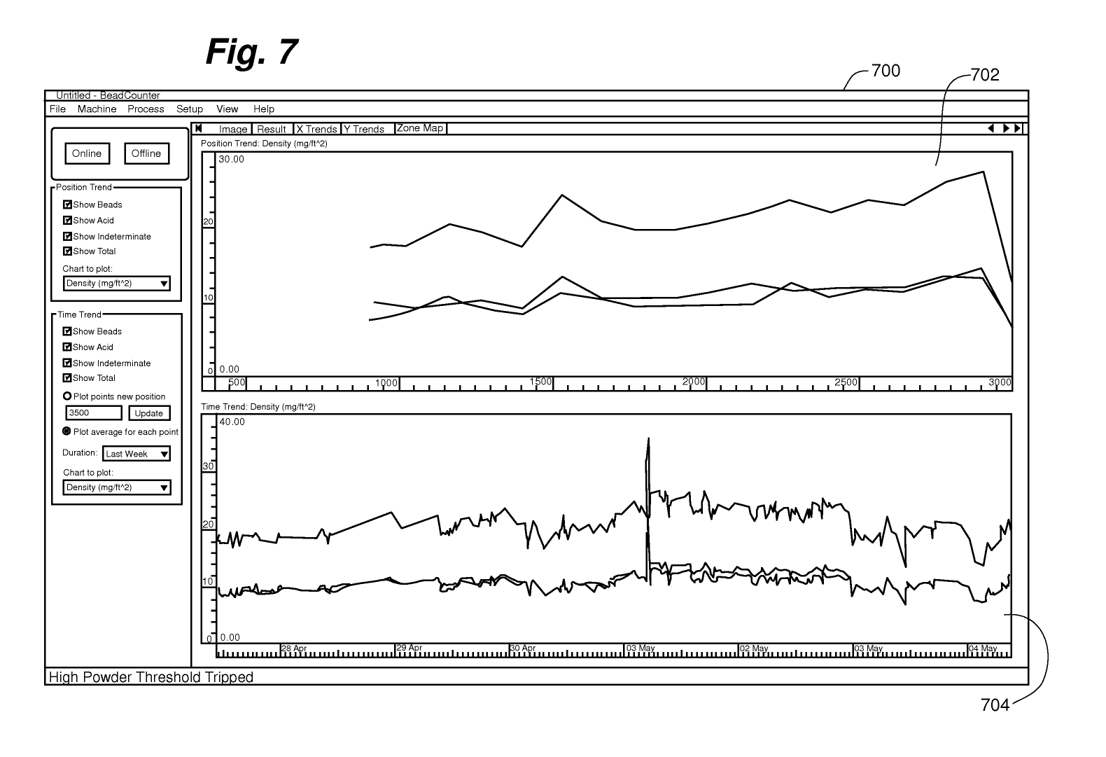

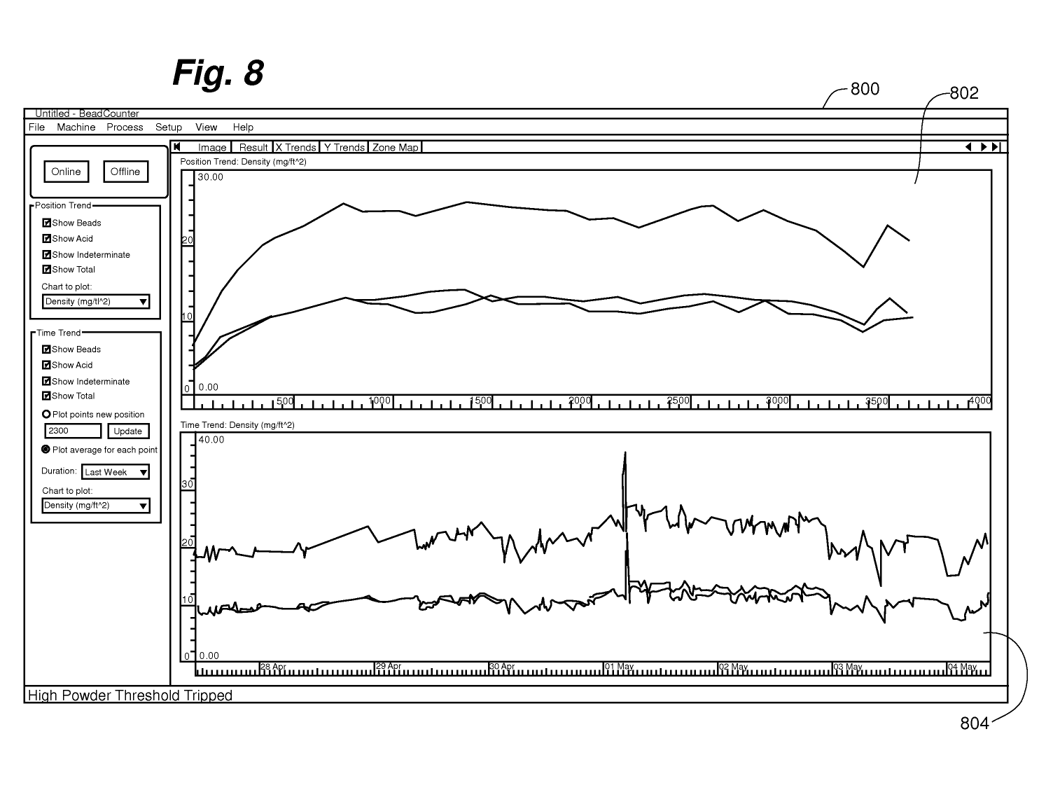

FIG. 7 illustrates a user interface 700 displaying a first graph 702 showing the total density of interleaving material, as well as the individual densities of beads, acid particles and indeterminate particles along an X axis of a lite, i.e., looking across the conveyor width in the cross-machine direction and across the width of the lites. The user interface 700 also includes a second graph 704 showing the average densities (individual and total) of the particles across the width of the lites over a period of time. FIG. 8 illustrates a user interface 800 displaying graphs 802 and 804, which plot similar quantities along a Y axis of the lite, i.e., in the machine direction along the length of the conveyor and along the length of the lite.

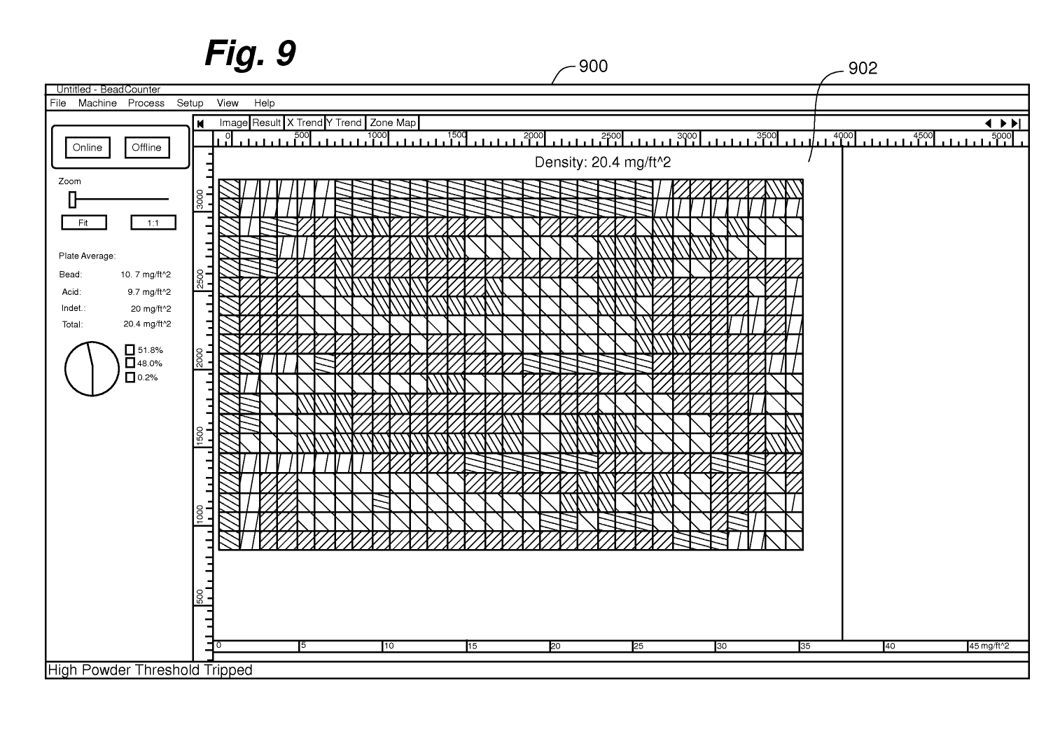

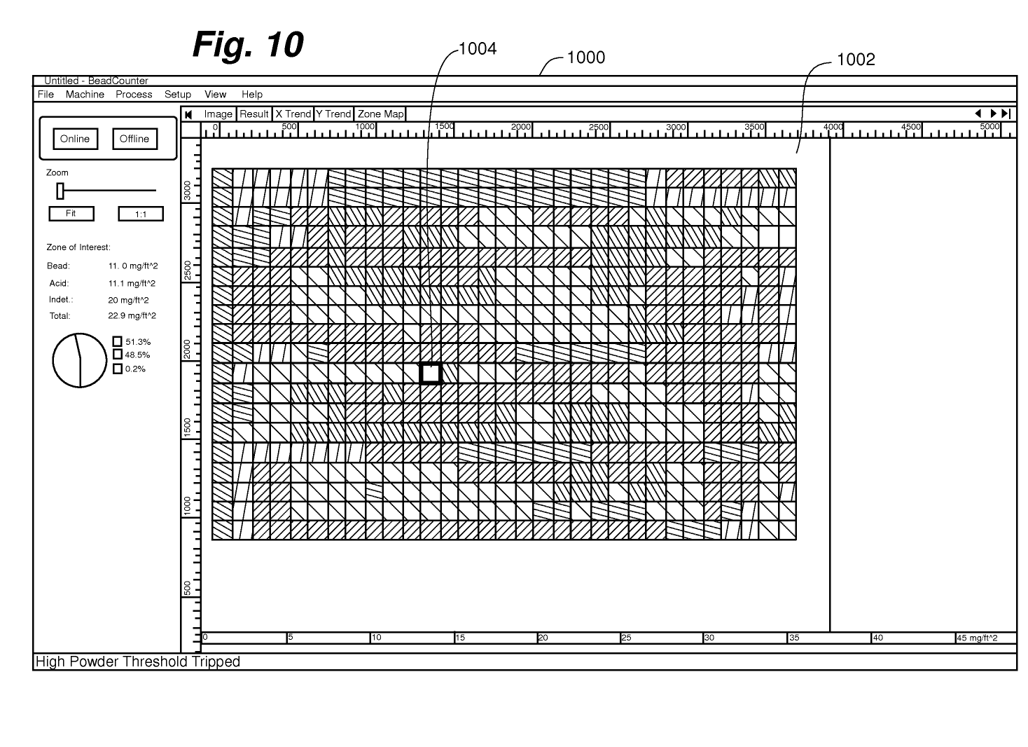

FIG. 9 is a depiction of a user interface 900 displaying a composite graph 902 of a lite graphically illustrating multiple density measurements across the surface of the lite, as well as average individual and total densities for the entire lite. FIG. 10 is a depiction of a similar user interface 1000 displaying a similar composite graph 1002 of a lite showing multiple density measurements across the surface of the lite. In addition, the user interface 1000 provides density information for different types of particles in a particular zone of interest 1004 on the lite. Of course these are just a few examples of possible data outputs following analysis of the interleaving material and it should be appreciated that a wide variety of graphs, charts, and other depictions of data according to different breakdowns are possible.

In addition to controlling the camera system 212 and providing for the analysis of the interleaving material and reporting of findings, the control module 214 may also provide a number of other features and capabilities. For example, in some cases the control module 214 is provided by a personal computer with all the standard capabilities and features normally provided in a computer. For example, in some cases the control module runs a commonly available operating system, such as Microsoft Windows, which provides a secure platform for mission critical applications. The control module 214 may also interface with plant control equipment via opto-isolated I/O, Ethernet, serial communications links, and/or other known communication standards. In some cases the control module is provided with networking capabilities, allowing the control module to be connected to an internal plant networking infrastructure. This can provide for remote interactive sessions to be run on monitors throughout the plant.

In addition, in some cases the control module 214 provides for manually driving the position of the camera head 220 to any desired location across the conveyor/lite in order to acquire an image of a particular location on the lite. The user interface shown in FIG. 5 includes one set of controls that can be used to manually move the camera head and capture images. In some cases the camera head 220 is automatically driven using a tracking plan. Tracking plans can allow the system to acquire a specified number of images at predefined positions and may be selectable on the fly. In addition, the control module 214 may be provided with comprehensive and flexible data logging facilities, which allow logging selections via, for example, point and click selection boxes. In some cases the system may also be provided with an uninterruptible power supply, which ensures that in the event of a power failure the system is closed down in an appropriate manner, preventing potential hardware faults caused by a sudden interruption of power.

A number of actions and outcomes are possible based on the captured images of the lites and the subsequent analysis. For example, the assessment can be a source of information for troubleshooting quality control problems with the interleaving material, which may be apparent from sticking, marking, sliding, staining, etc., of the stacked sheets of material. In addition, the interleaving material can be manually reviewed to determine potential problems with and/or adjustments for the interleaving material applicator. For example, if the material level is low at one point along the width of the lite, an operator may check for clogs and obstructions along the dispersion line of the applicator. A modification to the arrangement of the applicator spray bar (e.g., moving or disabling a nozzle) may also be necessary. In some cases, the control module processor is programmed to compare aspects of the current interleaving material coverage to a desired coverage profile. Thus, the interleaving material coverage can be automatically analyzed and potential adjustments determined without the need to stop the production line, extract a sample, and manually inspect the sample under a microscope to determine the coverage quality.

Some embodiments of the invention provide for using the assessment of interleaving material coverage to automatically adjust subsequent application of the interleaving material upon the lites. After comparing and determining desired adjustments to the current coverage, the processor may in some cases communicate the adjustments to the interleaving material applicator 206, e.g., over control line 215 shown in FIG. 2. In such cases the feedback may be provided in real-time during glass production, thus providing an online, closed-loop control for quickly adjusting application of the interleaving material, especially when compared with past methods of manually inspecting glass samples and manually adjusting application at some indeterminate time later.

According to some embodiments, the applicator 206 can receive a control signal from the control module 214 that allows the control module to adjust one or more aspects of the applicator based on the interleaving material analysis. For example, the applicator 206 may respond to a signal for adjusting a metering gap within the applicator and/or a vibration intensity. According to one example, the vibration setting of the applicator is adjusted using a 0-10 V analog signal supplied by the control module to the applicator. The magnitude of the signal sets the percentage of the current vibration setting being used for dispersing. For example, if the feedback signal from the controller to the applicator is 5V (50% of the range maximum of 10V), the vibration setting is reduced by half.

Once the system determines that a current density value is outside the acceptable range, the control module can quickly calculate a new control signal to modify the output of the applicator. In some cases the processor is programmed to potentially adjust the applicator's interleavant dispersion every 50 ms. Thus, the applicator can be updated very quickly after an analysis indicates there is a problem.

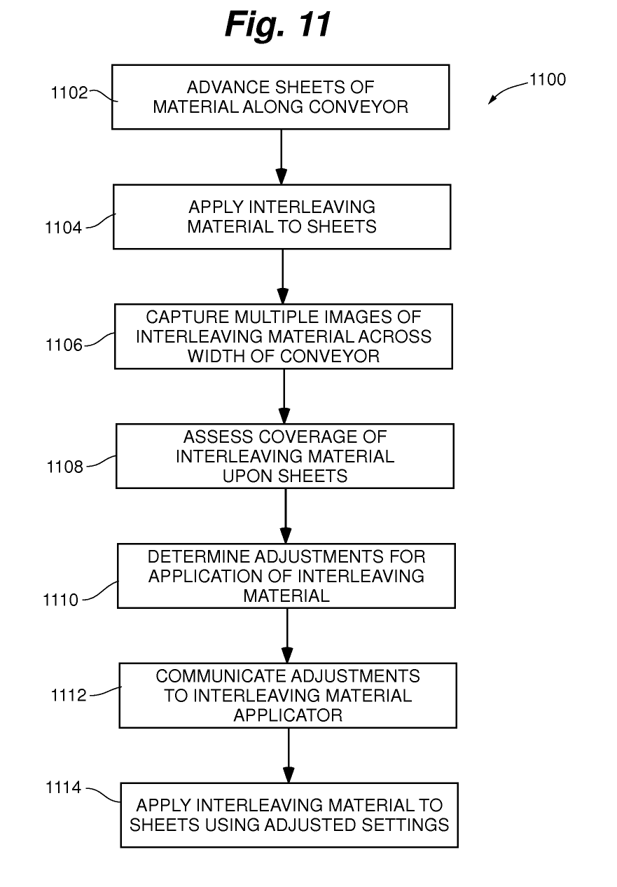

Turning to FIG. 11, embodiments of the invention also provide a method 1100 for analyzing interleaving material on sheets of material, e.g., lites, upon a conveyor. In some embodiments, the method also includes advancing 1102 sheets/lites along a conveyor and applying 1104 an interleaving material to the lites in any conventional manner. In some cases the method includes moving a camera head (e.g., automatically) along a support frame across the conveyor and capturing 1106 images of the interleaving material at multiple positions along the width of the conveyor. For example, the images may include a series of images at each of the positions, with one, two, or more images per lite. The method may further include assessing 1108 coverage of the interleaving material upon the lites from the multiple images, using, for example, computer processor-based image recognition techniques. Adjustments for application of the interleaving material may also be determined 1110 based on the assessed coverage, and in some cases the adjustments are communicated 1112 to an interleaving material applicator to adjust subsequent application 1114 of the interleaving material.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A system for analyzing interleaving material on sheets of material to be stacked, comprising:
a cross-conveyor support frame adapted to span across a conveyor advancing sheets of material to be stacked, the sheets of material having an interleaving material applied to at least one surface of the sheets of material;
a camera system coupled to the support frame and adapted to capture images of the interleaving material at multiple positions along a width of the conveyor; and
a control module coupled to the camera system, the control module comprising a processor programmed with instructions for analyzing the interleaving material, the analyzing comprising
receiving the images of the interleaving material from the camera system,
assessing coverage of the interleaving material upon the sheets of material from the images,
determining adjustments for application of the interleaving material based on the assessed coverage, and
communicating the adjustments to an interleaving material applicator.

2. The system of claim 1, wherein the camera system comprises a moving camera head adapted to move along the support frame to the multiple positions along the width of the conveyor.

3. The system of claim 2, wherein the processor is further programmed with instructions for moving the camera head to each of the multiple positions and actuating the camera system to capture multiple images at each of the multiple positions before moving the camera head to another of the multiple positions.

4. The system of claim 3, wherein the processor is further programmed with instructions for actuating the camera system to capture a single image per sheet of material advancing along the conveyor.

5. The system of claim 1, wherein the camera system comprises a plurality of cameras coupled to the support frame and located at the multiple positions along the width of the conveyor.

6. The system of claim 1, wherein the camera system comprises at least one light for illuminating the sheets of material and the interleaving material during image capture.

7. The system of claim 6, wherein the at least one light comprises a strobe light.

8. The system of claim 6, wherein the interleaving material comprises at least two types of particles and wherein the analyzing of the interleaving material further comprises distinguishing and assessing the coverage of each of the at least two types of particles.

9. The system of claim 8, wherein the at least two types of particles comprise separation beads and acid particles.

10. The system of claim 8, wherein the processor is further programmed with instructions for flashing the at least one light and actuating the camera system to capture illuminated images of the interleaving material during the flashing, wherein the at least two types of particles are distinguished based on light reflected from the particles in the illuminated images.

11. The system of claim 1, wherein the analyzing of the interleaving material further comprises generating a graph of a density of the interleaving material across at least a portion of the sheets of material.

12. The system of claim 1, wherein communicating the adjustments to the interleaving material applicator comprises the processor generating an electrical signal for adjusting a setting of the interleaving material applicator.

13. The system of claim 12, wherein the processor generates an electrical signal for adjusting a vibrational setting of the interleaving material applicator.

14. A system for applying an interleaving material to sheets of material to be stacked, comprising:
a conveyor adapted to advance sheets of material to be stacked;
an interleaving material applicator positioned proximate to the conveyor for applying an interleaving material to the sheets of material as they advance along the conveyor;
a cross-conveyor support frame spanning across the conveyor;
a camera system coupled to the support frame and adapted to capture images of the interleaving material at multiple positions along a width of the conveyor; and
a control module coupled to the camera system and the interleaving material applicator, the control module comprising a processor programmed with instructions for analyzing the interleaving material, the analyzing comprising
receiving the images of the interleaving material from the camera system,
assessing coverage of the interleaving material upon the sheets of material from the images,
determining adjustments for application of the interleaving material based on the assessed coverage, and
communicating the adjustments to the interleaving material applicator.

15. The system of claim 14, wherein the camera system comprises a moving camera head adapted to move along the support frame to the multiple positions along the width of the conveyor.

16. The system of claim 15, wherein the processor is further programmed with instructions for moving the camera head to each of the multiple positions and actuating the camera system to capture multiple images at each of the multiple positions before moving the camera head to another of the multiple positions.

17. The system of claim 16, wherein the processor is further programmed with instructions for actuating the camera system to capture a single image per sheet of material advancing along the conveyor.

18. The system of claim 14, wherein the camera system comprises at least one light for illuminating the sheets of material and the interleaving material during image capture.

19. The system of claim 18, wherein the interleaving material comprises at least two types of particles and wherein the analyzing of the interleaving material further comprises distinguishing and assessing the coverage of each of the at least two types of particles.

20. The system of claim 19, wherein the processor is further programmed with instructions for flashing the at least one light and actuating the camera system to capture illuminated images of the interleaving material during the flashing, wherein the at least two types of particles are distinguished based on light reflected from the particles in the illuminated images.

21. The system of claim 14, wherein communicating the adjustments to the interleaving material applicator comprises the processor generating an electrical signal for adjusting a setting of the interleaving material applicator.

22. The system of claim 21, wherein the processor generates an electrical signal for adjusting a vibrational setting of the interleaving material applicator.

23. A system for analyzing interleaving material on sheets of material to be stacked, comprising:
a cross-conveyor support frame adapted to span across a conveyor advancing sheets of material to be stacked, the sheets of material having an interleaving material applied to at least one surface of the sheets of material;
a camera system coupled to the support frame, the camera system comprising a moving camera head adapted to move along the support frame to multiple positions along a width of the conveyor and capture images of the interleaving material at the multiple positions, the camera system further comprising at least one light for illuminating the sheets of material and the interleaving material during image capture; and
a control module coupled to the camera system, the control module comprising a processor programmed with instructions for analyzing the interleaving material, the analyzing comprising
flashing the at least one light,
actuating the camera system to capture illuminated images of the interleaving material during the flashing,
receiving the illuminated images of the interleaving material from the camera system, and
assessing from the illuminated images coverage of each of at least two types of particles in the interleaving material upon the sheets of material.

24. The system of claim 23, wherein the at least two types of particles comprise separation beads and acid particles.

25. The system of claim 23, wherein the analyzing further comprises distinguishing the at least two types of particles based on light reflected from the particles in the illuminated images.

26. The system of claim 23, wherein the analyzing of the interleaving material further comprises generating a graph of a density of the interleaving material across at least a portion of the sheets of material.

27. The system of claim 23, wherein the analyzing of the interleaving material further comprises determining adjustments for application of the interleaving material based on the assessed coverage.

28. The system of claim 27, wherein the analyzing of the interleaving material further comprises communicating the adjustments to an interleaving material applicator.

29. The system of claim 28, wherein communicating the adjustments to the interleaving material applicator comprises the processor generating an electrical signal for adjusting a setting of the interleaving material applicator.

30. The system of claim 29, wherein the processor generates an electrical signal for adjusting a vibrational setting of the interleaving material applicator.

31. A method for analyzing interleaving material on sheets of material to be stacked, comprising:
moving a camera head along a support frame across a conveyor advancing sheets of material to be stacked, the sheets of material having an interleaving material applied to at least one surface of the sheets of material;
capturing with the camera head images of the interleaving material at multiple positions along a width of the conveyor;
assessing coverage of the interleaving material upon the sheets of material from the images;
determining adjustments for application of the interleaving material based on the assessed coverage; and
communicating the adjustments to an interleaving material applicator.

32. The method of claim 31, further comprising illuminating the sheets of material and the interleaving material and capturing with the camera head illuminated images of the interleaving material during the illumination.

33. The method of claim 32, wherein the camera head comprises at least one light for illuminating the sheets of material and the interleaving material during image capture.

34. The method of claim 33, wherein the at least one light comprises a strobe light.

35. The method of claim 31, wherein the interleaving material comprises at least two types of particles and further comprising distinguishing and assessing the coverage of each of the at least two types of particles.

36. The method of claim 35, wherein the at least two types of particles comprise separation beads and acid particles.

37. The method of claim 35, further comprising illuminating the sheets of material and the interleaving material, capturing with the camera head illuminated images of the interleaving material during the illumination, and distinguishing and assessing the coverage of each of the at least two types of particles based on light reflected from the particles in the illuminated images.

38. The method of claim 31, further comprising generating a graph of a density of the interleaving material across at least a portion of the sheets of material.

39. The method of claim 31, further comprising capturing multiple images at each of the multiple positions before moving the camera head to another of the multiple positions.

40. The method of claim 39, further comprising capturing a single image per sheet of material advancing along the conveyor.
